(19) United States
(12) Patent Application Publication
(10) Pub. No.: US 2014/0100985 A1
(43) Pub. Date: Apr. 10, 2014

(54) SYSTEM AND METHODS FOR CONNECTING BUYERS AND SELLERS

(71) Applicants: Michael Lenahan, Moraga, CA (US); Ben Mitchell, Oakland, CA (US); Chahn Chung, San Francisco, CA (US); Myra Sandoval, San Francisco, CA (US); Tim Suglian, San Francisco, CA (US)

(72) Inventors: Michael Lenahan, Moraga, CA (US); Ben Mitchell, Oakland, CA (US); Chahn Chung, San Francisco, CA (US); Myra Sandoval, San Francisco, CA (US); Tim Suglian, San Francisco, CA (US)

(73) Assignee: eBay Inc., San Jose, CA (US)

(21) Appl. No.: 14/050,923

(22) Filed: Oct. 10, 2013

Related U.S. Application Data
(60) Provisional application No. 61/712,214, filed on Oct. 10, 2012.

(51) Int. Cl. G06Q 30/06; G06Q 50/00

(52) U.S. Cl. CPC G06Q 30/0605; G06Q 50/01
USPC 705/26.4

(57) ABSTRACT

A system comprising a computer-readable storage medium storing at least one program, and a computer-implemented method for connecting buyers and sellers by scanning social networks, are described herein. Consistent with some embodiments, the method may include scanning social network entries made by users on one or more social network. The method may further include identifying keywords from the social network entries that indicate a product available for sale and identifying keywords that indicate a potential purchase of the product. In some embodiments, the method may include determining the intent of a user to purchase a product. The method may further include determining a first user (e.g., a potential buyer) and a second user (e.g., a potential seller) are a match based on the two users referring to the same or similar products in one or more social network entries. In response to determining that the first user and the second user are a match, the two uses may be communicatively connected.

### RELATED APPLICATIONS

This application claims the benefit under of U.S. Provisional Patent Application Ser. No. 61/712,214 filed Oct. 10, 2012, which is incorporated herein by reference in its entirety and made a part thereof.

### TECHNICAL FIELD

The subject matter disclosed herein generally relates to systems and methods for connecting buyers and sellers. In particular, systems and methods disclosed herein may scan social networking sites to find keywords indicative of a person's desire or need to sell or buy a product and connect potential sellers and buyers.

### BACKGROUND

One of the difficulties in buying or selling a product is finding a buyer for the product that one is selling, or finding a seller who is selling the product of interest. However, people use social sites and social networking daily to connect with other people over the Internet. However, people also share many personal details over these social sites that provide insights into a person's needs, wants, and future behavior.

### BRIEF DESCRIPTION OF THE DRAWINGS

Various ones of the appended drawings merely illustrate example embodiments of the present invention and cannot be considered as limiting its scope.

FIG. 1 is a network diagram depicting a network system having a client-server architecture configured for exchanging data over a network, according to an example embodiment.

FIG. 2 is a block diagram illustrating an example embodiment of multiple marketplace and payment applications, which are provided as part of the network system.

FIG. 3 is a block diagram illustrating an example embodiment of multiple modules forming a social scan application, which is provided as part of the network system.

FIG. 4 is a screenshot illustrating an example social network activity feed with example social network entries, consistent with some embodiments.

FIG. 5 is a screenshot illustrating an example interface for connecting buyers and sellers, consistent with some embodiments.

FIG. 6 is a flowchart illustrating an example of a method for connecting buyers and sellers by scanning social information, consistent with some embodiments.

FIG. 7 is a block diagram illustrating a computing device, according to an example embodiment.

FIG. 8 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the spirit and scope of the disclosure as defined by the appended claims. In the following description, specific details are set forth in order to provide a thorough understanding of the subject matter. Embodiments may be practiced without some or all of these specific details.

In accordance with the present disclosure, components, process steps, and data structures may be implemented using various types of operating systems, programming languages, computing platforms, computer programs, and/or general purpose machines. In addition, those of ordinary skill in the art will recognize that devices of a less general purpose or nature, such as hardwired devices, field programmable gate arrays (FPGAs), application specific integrated circuits (ASICs), or the like, may also be used without departing from the scope and spirit of the concepts disclosed herein.

Aspects of the present disclosure describe systems and methods for connecting buyers and sellers by scanning social networks. The systems and methods provided herein may allow for the connection of potential buyers of a product to potential sellers of the same or similar products by scanning users' messages on social networking sites for keywords indicating a need or want to sell or buy a particular product.

Consistent with some embodiments, the method may include scanning social network entries made by users on one or more social network. The method may further include identifying keywords from the social network entries that indicate a product that may be available for sale and identifying keywords that indicate a potential purchase of the product. In some embodiments, the method may include determining the intent of a user to purchase a product. The method may further include determining that a first user (e.g., a potential buyer) and a second user (e.g., a potential seller) are a match based on the two users referring to the same or similar products in one or more social network entries. In response to determining that the first user and the second user are a match, the two users may be communicatively connected. In some embodiments, communicatively connecting the two users may include transmitting a message (e.g., email, SMS text message, Instant Message (IM), or the like) to each of the users notifying each of the other's intent (e.g., intent of the potential seller to sell the product, and the intent of the potential buyer to buy the product).

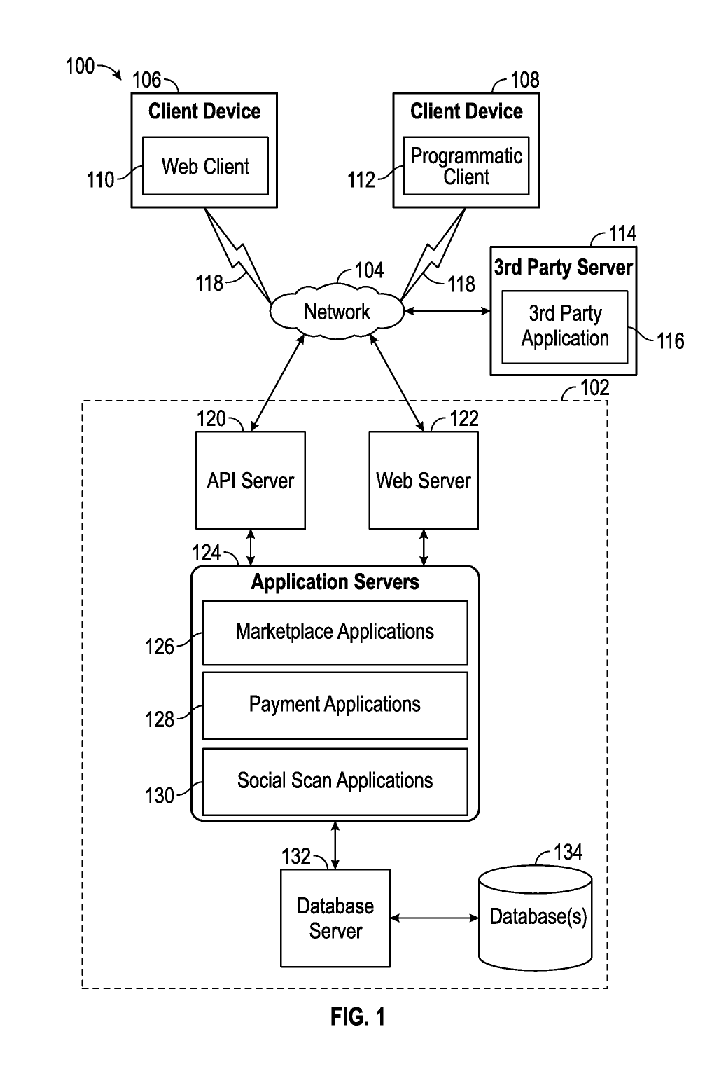

FIG. 1 is a network diagram depicting an example network system 100, according to one embodiment, having a client-server architecture configured for exchanging data over a network. For example, the network system 100 may be a network-based marketplace 102 where clients may communicate and exchange data within the network system 100. The data may pertain to various functions and aspects associated with the network system 100 and its users.

A data exchange platform, in an example form of the network-based marketplace 102, may provide server-side functionality, via a network 104 (e.g., the Internet), to one or more client devices. The one or more client devices may be operated by users that use the network system 100 to exchange data over the network 104. These transactions may include transmitting, receiving (communicating), and processing data to, from, and regarding content and users of the network system 100. The data may include, but are not limited to: images; video or audio content; user preferences; product and service feedback, advice, and reviews; product, service, manufacturer, and vendor recommendations and identifiers; product and service listings associated with buyers and sellers; product and service advertisements; auction bids; and transaction data, among other things.

In various embodiments, the data exchanges within the network system 100 may be dependent upon user-selected functions available through one or more client or user interfaces (UIs). The UIs may be associated with a client device, such as a client device 106 using web client 110. The web client 110 may be in communication with the network-based marketplace 102 via a web server 122. The UIs may also be associated with a client device 108 using a programmatic client 112, such as a client application, or a third party server 114 (e.g., one or more servers or client devices) hosting a third party application 116. It can be appreciated that, in various embodiments, the client devices 106, 108, and/or the third party server 114 may be associated with a buyer, a seller, a third party electronic commerce platform, a payment service provider, or a shipping service provider, each in communication with the network-based marketplace 102 and optionally with each other. The buyers and sellers may be any one of individuals, merchants, or service providers, among other things.

The client devices 106 and 108 may be any of a variety of types of devices. For example, the client devices 106 and 108 may a mobile device such as a smartphone such as an iPhone™ or other mobile device running the iOS™ operating system, the Android™ operating system, a BlackBerry™ operating system, the Microsoft® Windows® Phone operating system, Symbian™ OS, or webOS™. Consistent with some embodiments, the client devices 106 and 108 may alternatively be a tablet computer, such as an iPad™ or other tablet computer running one of the aforementioned operating systems. In some embodiments, the client device 106 and 108 may also be a personal digital assistant (PDA), a personal navigation device (PND), a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, or a video game system console such as the Nintendo® Wii™, the Microsoft® Xbox 360™, or the Sony® PlayStation™ 3, or other video game system consoles.

Consistent with some embodiments, the client devices 106 and 108 may include any appropriate combination of hardware and/or software having one or more processors and capable of reading instructions stored on a non-transitory machine-readable medium for execution by the one or more processors. Consistent with some embodiments, the client devices 106 and 108 may include a machine-readable medium, such as a memory (not shown) that includes instructions for execution by one or more processors (not shown) for causing the client devices 106 and 108 to perform specific tasks. For example, such instructions may include viewing, purchasing, and selling products through marketplace and payment applications 126 and 128. Further, content may be displayed by particular applications or “apps” stored in a memory of the client devices 106 and 108 and executed by one or more processors executing in the client devices 106 and 108. One example of an application is a browser application that displays content, such as a web page or a user interface using a browser, a marketplace application that is used to interact with an online marketplace that may be provided by application server 124. The client devices 106 and 108 may also include social applications (e.g., Facebook, Twitter, Google+, Pinterest, Svpply, or the like) in communication with a third party server 114.

The client devices 106 and 108 may interface via a connection 118 with a communication network 104 (e.g., the Internet or Wide Area Network (WAN)). Depending on the form of the client device 106 and 108, any of a variety of types of connections 118 and communication networks 104 may be used. For example, the connection 118 may be Code Division Multiple Access (CDMA) connection, a Global System for Mobile communications (GSM) connection, or other type of cellular connection. Such a connection 118 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 118 may be Wireless Fidelity (Wi-Fi, IEEE 802.11x type) connection, a Worldwide Interoperability for Microwave Access (WiMAX) connection, or another type of wireless data connection. In such an embodiment, the communication network 104 may include one or more wireless access points coupled to a local area network (LAN), a WAN, the Internet, or other packet-switched data network. In yet another example, the connection 118 may be a wired connection, for example an Ethernet link, and the communication network 104 may be a LAN, a WAN, the Internet, or other packet-switched data network. Accordingly, a variety of different configurations are expressly contemplated.

FIG. 1 also illustrates a third party application 116 executing on the third party server 114 that may offer one or more services to users of the client devices 106 and 108. The third party application 116 may have programmatic access to the network-based marketplace 102 via the programmatic interface provided by an application program interface (API) server 120. In some embodiments, the third party application 116 may be associated with a vendor, a merchant, or any organizations that may conduct transactions with the users of the client devices 106 and 108. For some example embodiments, the third party application 116 may be associated with an online marketplace (e.g., eBay, Inc. of San Jose, Calif.). In some embodiments, the third party application 116 may correspond to a social network (e.g., Facebook, Twitter, Google+, Pinterest, Svpply, or the like).

Turning specifically to the network-based marketplace 102, the API server 120 and a web server 122 are coupled to, and provide programmatic and web interfaces respectively to, one or more application servers 124. The application servers 124 host one or more marketplace applications 126, payment applications 128, and social scan applications 130, which may be configured to scan the social network connections and social interactions on social networking sites of users to attempt to connect potential buyers to potential sellers of products. The application servers 124 may be coupled via these interfaces to the communication network 104, for example, via wired or wireless interfaces. The application servers 124 are, in turn, shown to be coupled to one or more database servers 132 that facilitate access to one or more databases 134. In some examples, the application servers 124 can access the databases 134 directly without the need for a database server 132. In some embodiments, the databases 134 may include databases both internal and external to the network-based marketplace 102.

The marketplace applications 126 may provide a number of marketplace functions and services to users that access the network-based marketplace 102. The payment applications 128 may likewise provide a number of payment services and functions to users. The payment applications 128 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 126. For some example embodiments, the payment applications 128 generally enable transfer of values (e.g., funds, reward points, etc.) from an account associated with one party (e.g., a sender) to another account associated with another party (e.g., a receiver). To perform the value transfer, execution of the payment applications 128 may be based on one or more approval flows. This may require having access or the rights to initiate these approval flows and to use the services of a payment facilitator. One example of a payment facilitator is PayPal, Inc. of San Jose, Calif. Having access may not include having approval to transfer the values out of the sender's account, while having approval may implicitly include having access.

While the marketplace, payment, and social scan applications 126, 128, and 130 are shown in FIG. 1 to all form part of the network-based marketplace 102, it will be appreciated that, in alternative embodiments, the social scan applications 130 may form part of a service that is separate and distinct from the network-based marketplace 102. Further, while the system 100 shown in FIG. 1 employs client-server architecture, the present inventive subject matter is, of course, not limited to such an architecture, and could equally well find application in an event-driven, distributed, or peer-to-peer architecture system, for example. The various modules of the application servers 124 may also be implemented as standalone systems or software programs, which do not necessarily have networking capabilities.

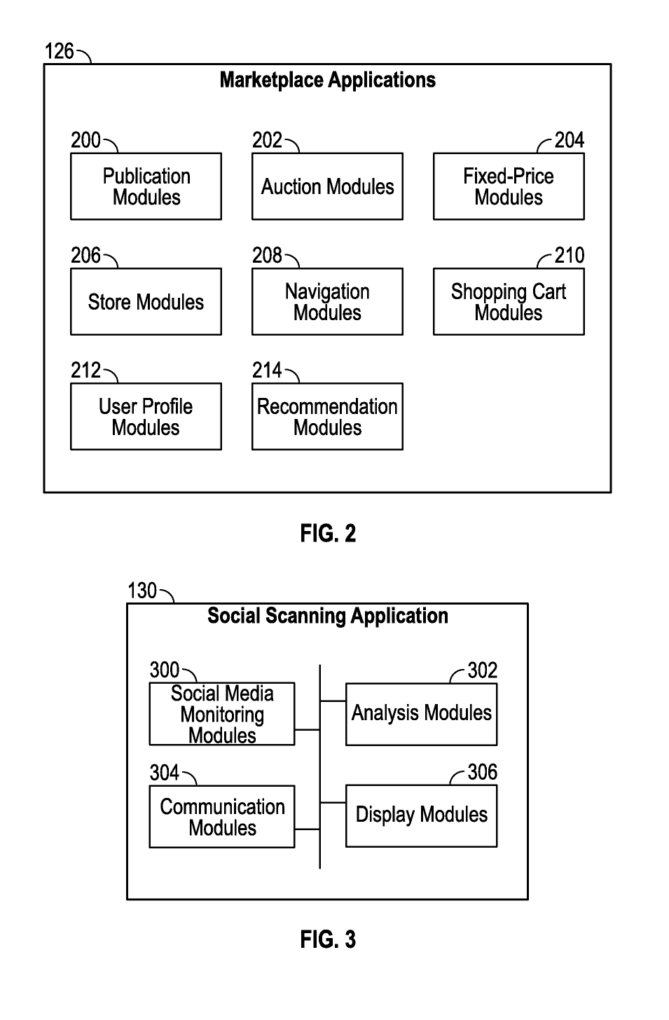

FIG. 2 is a block diagram illustrating an example embodiment of multiple modules forming the marketplace applications 126, which are provided as part of the network system 100. The modules of the marketplace applications 126 may be hosted on dedicated or shared server machines that are communicatively coupled to enable communications between server machines. Each of the modules 200-214 are communicatively coupled (e.g., via appropriate interfaces) to each other and to various data sources, so as to allow information to be passed between the modules 200-214 of the marketplace applications 126 or so as to allow the modules 200-214 to share and access common data. The various modules of the marketplace applications 126 may furthermore access one or more databases 134 via the database servers 132.

The marketplace applications 126 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 126 are shown to include at least one publication module 200 and one or more auction modules 202, which support auction-format listing and price setting mechanisms (e.g., English, Dutch, Vickrey, Chinese, Double, Reverse auctions etc.). The various auction modules 202 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price modules 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store modules 206 may allow sellers to group their product listings (e.g., goods and/or services) within a “virtual” store, which may be branded and otherwise personalized by and for the sellers. Such a virtual store may also offer promotions, incentives, and features that are specific and personalized to a relevant seller. In one embodiment, the listings and/or transactions associated with the virtual store and its features may be provided to one or more users.

Navigation of the network-based marketplace 102 may be facilitated by one or more navigation modules 208. For example, a search module may, inter alia, enable key word searches of listings published via the marketplace 102. A browser module may allow users via an associated UI to browse various category, catalogue, inventory, social network, and review data structures within the marketplace 102. Various other navigation modules 208 (e.g., an external search engine) may be provided to supplement the search and browsing modules. Consistent with some embodiments, the results for key word searches of listings published via the marketplace 102 may be filtered to include only listings corresponding to social network connections of the user (e.g., indicated friends and family).

In one embodiment, electronic shopping cart modules 210 are used to create an electronic shopping cart used by users of the network-based marketplace 102 to add and store products (e.g., goods and services) listed by the store modules 206. The electronic shopping cart modules 210 may also be used to “check out,” meaning a user may purchase products in the electronic shopping cart. The electronic shopping cart modules 210 may facilitate the transactions by automatically finding the products in the electronic shopping cart across at least one or all of a predefined set of vendors, a comparison shopping site, an auction site, etc. In various embodiments, the selection criteria for which vendor or vendors to purchase from may include, but is not limited to, criteria such as lowest cost, fastest shipping time, preferred or highest rated vendors or sellers, or any combination thereof.

As illustrated in FIG. 2, the marketplace applications 126 may also include one or more user profile modules 212, which are used to generate and maintain a user profile for each user of the networked system 100. Each user profile may be stored and maintained in the database 134. Each user profile comprises a user data that describes aspects of a particular user. The user data may include demographic data, user preferences, user activity, and user account information. Accordingly, the user profile modules 212 may be configured to monitor, track, and record the activities and interactions of a user, using one or more devices (e.g., client device 106), with the various modules of the network system 100. The user profile modules 212 may store each user session as an activity set and maintain each activity set as part of the user data. Accordingly, in some embodiment, the user data may include past product searches that users have performed, products added to a user wish list or watch list, products added to an electronic shopping cart, products that the users own, and any themes that a user has indicated they would like to find more products related to. In some embodiments, the user preferences may be inferred by the user profile modules 212 from the user activity.

In some embodiments, the user profile modules 212 may work in conjunction with the navigation modules 208 to monitor and store the activity of the user associated with the searching and browsing of listings published via the network-based marketplace 102. Accordingly, the user profile may also include a transaction history of the user. Transaction history may include information related to transactions for items or services (e.g., products) offered for sale by a network based marketplace 102. The transaction history information may, for example, include a description of a product purchased by the user, an identifier of the product, a category to which the product belongs, a purchase price, a quantity, or a number of bids.

The demographic data included as part of the user profile may include information describing one or more characteristics of a user. Demographic data may, for example, include gender, age, location information, employment history, education history, contact information, familial relations, or user interests.

The user account information included in each user profile may, for example, include private financial information of users of devices such as account numbers, credentials, passwords, device identifiers, user names, phone numbers, credit card information, bank information, or other financial information which may be used to facilitate online transactions by users.

In some embodiments, the user profile may also include a list of social network connections of the user. For purposes of the present disclosure, a social network “connection”, also referred to as being “connected” on a social network, may include both a bi-lateral agreement between members of the social network as well as situations in which there is only a unilateral acknowledgement of the “connection.” In the bi-lateral agreement situation, both members of the “connection” acknowledge the establishment of the connection (e.g., friends). Similarly, in the unilateral acknowledgement situation, a member may elect to “follow” or “watch” another member. In contrast to bi-lateral agreement, the concept of “following” another member typically is a unilateral operation because it may not call for acknowledgement or approval by the member that is being followed. The social network connections of a user may be retrieved via an API from one or more social networks.

As illustrated in FIG. 2, the marketplace applications 126 may include one or more recommendation modules 214, which may provide recommendation services and functions to users. In some embodiments, the recommendation modules 214 may receive requests for recommendations, and, in turn, provide a recommendation to the user based on information contained in the user's corresponding user profile. In some embodiments, the recommendation modules 214 may automatically generate and provide a recommendation based on the activity of the user. The recommendations provided by the recommendation modules 214 may contain one or more items (e.g., products offered for sale, articles, blogs, movies, social network connections, etc.) that may potentially interest a user. The recommendations may, for example, be based on previous products purchased by the user or a social network connection of the user, a web page viewed by the user, or an item given favorable feedback by the user or a social connection of the user.

FIG. 3 is a block diagram illustrating an example embodiment of multiple modules forming the social scan applications 130, which are provided as part of the network-based marketplace 102. The social scan applications 130 are shown as including one or more social network monitoring modules 300, analysis modules 302, communication modules 304, and display modules 306 all configured to communicate with each other (e.g., via a bus, shared memory, a switch, or application programming interfaces (APIs)). The various modules of the social scan applications 130 may furthermore access one or more databases 134 via the database servers 132, and each of the various modules of the social scan applications 130 may each be in communication with one or more third party applications 116.

As illustrated in FIG. 3, the social scan applications 130 may include one or more social media monitoring modules 300, which are used to retrieve and track publically available entries made on one or more social networks. Depending on the social network, these entries may, for example, include an activity feed post, a wall post, a status update, a tweet, a pinup, a like, or a check-in. For purposes of the present disclosure, a “check-in” refers to a service provided by a social network that allows users to “check-in” to a physical space and share their location with other users of the social network. In some embodiments, a user may check-in to a specific location by sending a text message to the relevant social network service. Consistent with some embodiments, users may check-in to a specific location by using a mobile application provided by the social network on a client device (e.g., client device 106). The social network mobile application may use the GPS functionality of the client device to find the current location of the user and allow the user to share this information with other users of the social network.

The social media monitoring modules 300 may obtain social network entries via publically accessible APIs provided by each of the one or more social networks. In some embodiments, the social media monitoring modules 300 may obtain social networks entries made by users of the network-based marketplace 102, and maintain each entry as part of the user data comprising each of the respective user's profiles, which are stored in databases 134. In some embodiments, the social media monitoring modules 300 may obtain social networks entries made by connections of users of the network-based marketplace 102, and maintain each entry as part of the user data comprising each of the respective user's profiles, which are stored in databases 134.

As illustrated in FIG. 3, the social scan applications 130 may include one or more analysis modules 302, which may be used to analyze the social network entries obtained by the social media monitoring modules 300. The analysis modules 302 may analyze social network entries to identify certain keywords from the entries that are indicative of a desire of a user to either purchase or sell a particular product or service. These keywords may be separated into two categories: 1) buyer keywords, and 2) seller keywords. The buyer keywords are terms or phrases that are indicative of a desire of a user to purchase a particular product (e.g., an item or a service). For example, a social network entry stating, “I want the new PlayStation 4!!” would be indicative of the user's desire to purchase a new PlayStation 4. In another example, a social network entry stating, “I just dropped my iPhone, and now the screen is cracked. This is going to be so expensive to replace,” may be indicative of the user's desire to purchase a new iPhone. A particular user whose social network entry is identified as having one or more buyer keywords may be marked by the analysis modules 302 as a potential buyer and such information may be maintained as part of the user data comprising the particular user's user profile.

The seller keywords are terms or phrases that are indicative of a desire of a user to sell a particular product (e.g., an item or service). For example, a social network entry stating, “I just got a new couch, anybody want my old one? I will sell it for cheap” is indicative of the user's desire to sell a new couch. A particular user whose social network entry is identified has having one or more seller keywords may be marked by the analysis modules 302 as a potential seller and such information may be maintained as part of the user data comprising the particular user's user profile.

In some embodiments, the identification of keywords performed by the analysis modules 302 may comprise performing natural language processing for each entry to mine terms and phrases from each entry that are indicative of the desire to purchase or sell a product. In some embodiments, the terms and phrases used in the entries may be compared to a database of known terms or phrases that are indicative of a desire or intent to purchase or sell one or more products.

The analysis modules 302 may also identify one or more products (e.g., items or services) from the social network entries in conjunction with the identification of the keywords. The analysis modules 302 may identify the one or more products or services in accordance with the methodologies discussed above in reference to identifying keywords. The analysis modules 302 may use the identified products and services to locate listings (e.g., hosted by the network-based marketplace 102) corresponding to the identified products or services, or similar products and services.

In some embodiments, the analysis modules 302 may further match a potential buyer with a potential seller. In some embodiments, the determination of the potential buyer being a match may be based on a relationship between the products being referenced by the potential seller and the potential buyer in the respective social network entries of each. Consistent with some embodiments, the analysis modules 302 may determine that a potential buyer and a potential seller are both referring to a common product, and thus, the potential buyer and the potential seller are a match. Consistent with some embodiments, the analysis modules 302 may determine that a potential buyer and a potential seller are both referring to related products (e.g., different versions of the same product, similar products made by different manufactures, etc.) and thus, the potential buyer and the potential seller may be a match

In some embodiments, the analysis module 302 may work in conjunction with the recommendation modules 214 to recommend one or more listings (e.g., hosted on the network-based marketplace 102) to a potential buyer. The one or more listings may correspond to an identical or similar product referenced in a social network entry made by the potential buyer. In some embodiments, the listings included in such recommendations may correspond to listings of social network connections of the users.

As illustrated in FIG. 3, the social scan applications 130 may include one or more communication modules 304, which may facilitate communications between users. In some embodiments, the communication module 304 may be used for generation and delivery of messages to users of the network-based marketplace 102. In some embodiments, the communication module 304 may be used for generation and delivery of messages between a potential buyer and a potential seller. Such messages may, for example, include an indication of the match between a potential buyer and a potential seller.

Respective communication modules 304 may utilize any one of a number of message delivery networks and platforms to deliver messages to users. For example, the communication modules 304 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks. In some embodiments, the communication modules 304 may be used to generate social network entries to be posted on one or more social networks on behalf of a user. The social network entries may include one or more hyperlinks that may automatically redirect a user's browser to a particular marketplace listing.

As illustrated in FIG. 3, the social scan applications 130 may include one or more display modules 306. The display module 306 may control information or data that is provided to client systems for display on the client device 106. The display module 306 may be configured to generate and provide instructions to present web pages, user interfaces, search results, recommendation results, and other information retrieved from the database 134.

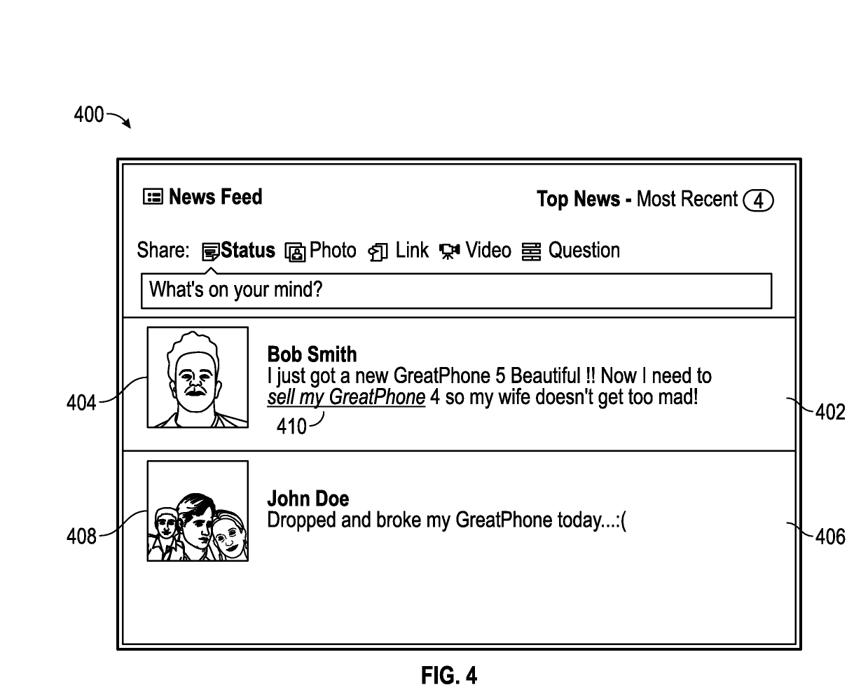

FIG. 4 is a screenshot illustrating an example social network activity feed 400 including example social network entries 402 and 406, consistent with some embodiments. As shown in FIG. 4, the activity feed 400 includes social network entries 402 and 406 posted by user 404 and user 408, respectively. As shown in FIG. 4, user 404 specifically posts the need to sell his iPhone 4, while user 408 indicates that his iPhone is broken. Through processing of the words “sell my iPhone 4” and “broke my iPhone,” the analysis modules 302 may identify the user 404 as a potential seller and the user 408 as a potential buyer. In particular, it is clear from the screenshot that both users are referring to a common product, an iPhone, and that the user 404 needs to sell the product while the user 408 needs to purchase the product. Because the user 404 is interested in selling a particular product that matches the product that the user 408 is interested purchasing, the users may be matched and connected by the social scan applications 130.

As illustrated in FIG. 4, the social network entry 402 also includes hyperlink 410, which, when selected by a user, may redirect the user's browser to the marketplace listing (e.g., hosted by the network-based marketplace 102) of the user 404 for the product (e.g., an iPhone) that the user 404 intends to sell. In some embodiments, in response to the analysis modules 302 determining that the user 404 and the user 408 are a match, the communication modules 304 may generate a message to the user 408 indicating that the user 404 is potentially selling a product that is of interest to the user 408. In some embodiments, the message may also include a hyperlink (e.g., hyperlink 410) that may direct the browser of the user 408 to the listing of the user 404.

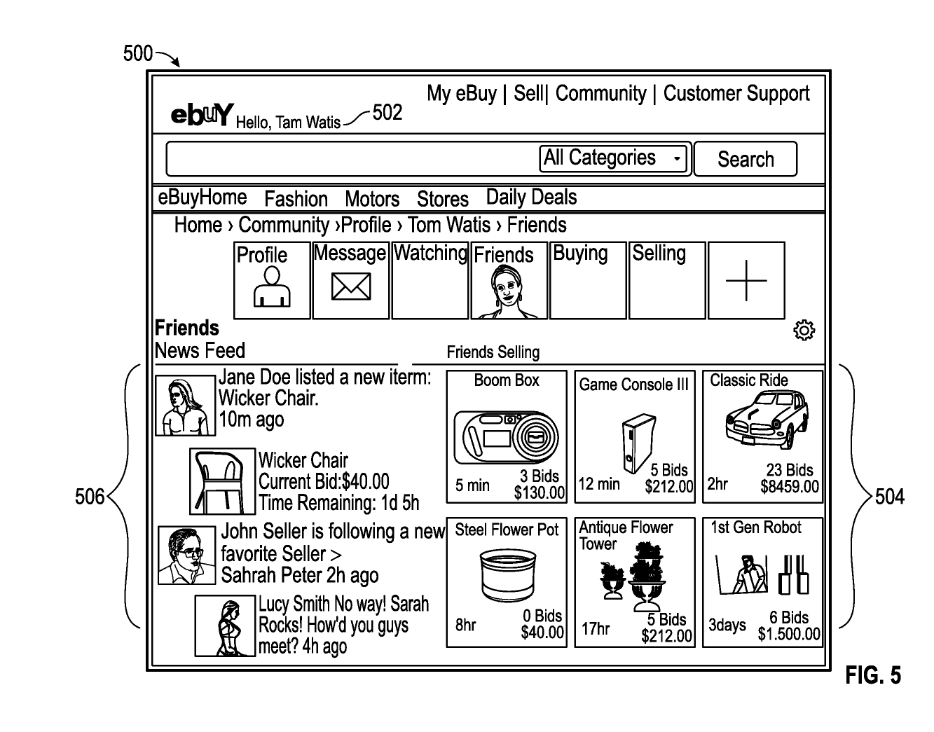

FIG. 5 is a screenshot illustrating an example interface 500 for connecting buyers and sellers, consistent with some embodiments. As shown in FIG. 5, the interface 500 may include a group of marketplace listings 504, which may comprise marketplace listings from various social network connections of a user 502. The group of marketplace listings 504 may be filtered such that each marketplace listing presented in the group of marketplace listings 504 corresponds to a social network of the user 502.

As illustrated in FIG. 5, interface 500 may include a news feed 506, which includes a list of recent activity of the social network connections of user 502. In this manner, the user 502 may quickly view products (e.g., items or services) that his social network connections are currently selling or interested in purchasing. Information included in the news feed 506 may be retrieved from the user data maintained as part of the user profile of each of these social network connections, and in some embodiments, the information may include information retrieved via an API from one or more social networks (e.g., the third party applications 116 hosted on the third party servers 114).

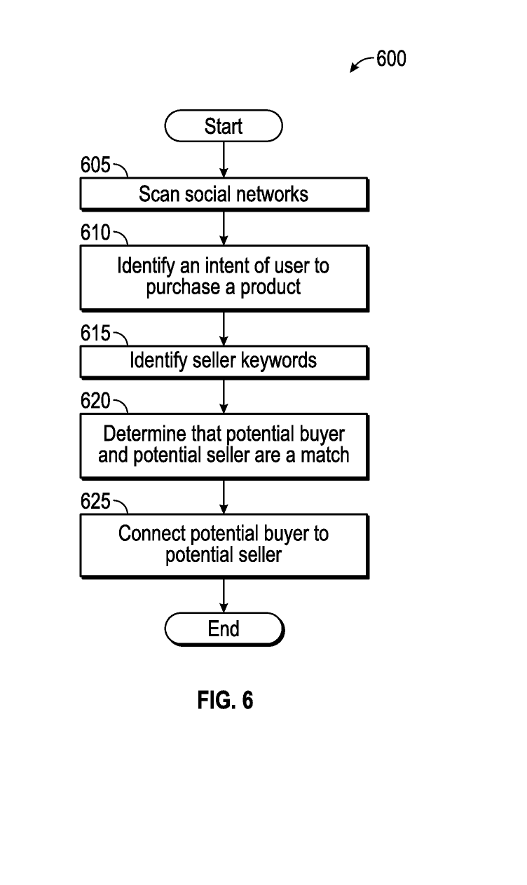

FIG. 6 is a flowchart illustrating an example method 600 for connecting buyers and sellers by scanning social information, consistent with some embodiments. For the purpose of illustration, FIG. 6 may be described with reference to FIGS. 1-5. The method 600 shown in FIG. 6 may be embodied in computer-readable instructions for execution by one or more processors such that the steps of the method 600 may be performed by the client device 106, the client device 108, or application server 124 and, in particular, social applications of the client devices 106 and 108, or social scan application 130 of application server 124. In this example, the method 600 may include operations such as scanning a social network at operation 605, identifying intent of a user to purchase a product at operation 610, identifying seller keywords from a social network entry at operation 615, and connecting the potential buyer with the potential seller at operation 625.

As shown in FIG. 6, the social media monitor modules 300 may monitor posts made on one or more social networks by users of the one or more social networks at operation 605. Consistent with some embodiments, users that may be potential buyers or potential sellers may be interacting with social networking sites using mobile social applications executing on the client device 106. This information may be publicly accessible and available to be scanned by the social media monitor module 300. Alternatively, a user of the network-based marketplace 102 may the network-based marketplace 102 permission to access their social networking sites to learn more about the user. In addition, users of the network-based marketplace 102 may have social connections within the context of the application server 124 that are saved in the user's profile.

At operation 610, an intent of a first user to purchase a product is identified. Consistent with some embodiments, the identifying of the intent of the first user to purchase a product may comprise the analysis module 302 identifying buyer keywords from a first user's social network entry. The first user's social network entry may identify a product, and the buyer keywords may indicate an intent, need, or desire to buy the product. In some embodiments, the identifying of the intent of the first user to purchase an product may be based on one or more key word searches (e.g., key word searches enabled by the navigation modules 208) performed by the first user for listings published via the marketplace 102 that are related to the product.

At operation 615, the analysis module 302 may identify seller keywords from a second user's post. The seller keywords may identify a product and indicate an intent, need, or desire to sell the product. An example of operations 610 and 615 are shown in FIG. 4, in which a first user specifically posts the need to sell their iPhone 4, while a second user indicates that their iPhone broken. By scanning the words “sell my iPhone 4” and “broke my iPhone”, analysis modules 302 may identify the first user as a potential seller and the second user as a potential buyer. It will be appreciated that the identification of the first user as a potential seller may occur at any time before, after, or simultaneously with the identification of the potential buyer. Similarly, the identification of the second user as a potential buyer may occur at any time before, after, or simultaneously with the identification of the potential seller.

Returning to FIG. 6, at operation 620, the analysis module 302 may attempt to match a potential buyer of a product to a potential seller of the product. Accordingly, at operation 620 the analysis module 302 may determine that the first user is a potential buyer, the second user is a potential seller, and the first user and the second user are a match. In the context of the example shown in FIG. 4, the analysis module 302 may determine that both users 404 and 408 are referring to a common product, an iPhone, and that user 404 needs to sell the product while user 408 needs to buy the product.

In response to determining that the first user and the second user are a match, the social scan application 130 may communicatively connect the potential buyer to the potential seller at operation 625. Returning to the FIG. 4 example, because user 404 is interested in selling a particular product that matches the product that user 408 is interested in purchasing, there is a match, and the user 404 may be communicatively connected to the user 408. Consistent with some embodiments, the communication module 304 may communicatively connect potential buyers to potential sellers by sending an e-mail, short messaging service (SMS), or other notification, or may connect them within the social network, or within the context of accessing the application server 124.

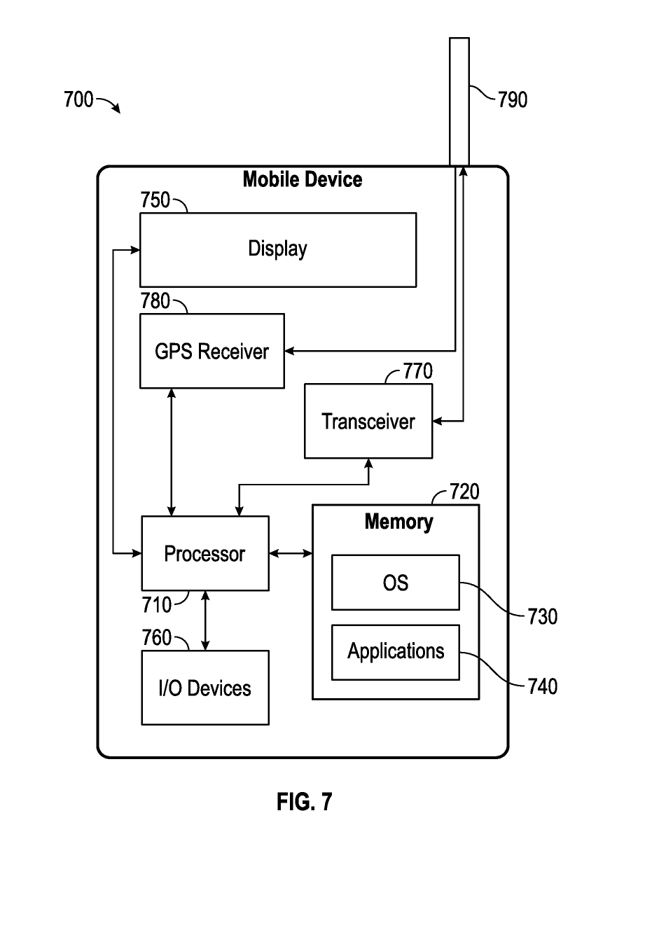

FIG. 7 is a block diagram illustrating a computing device 700, which may correspond to client device 106 or client device 108, consistent with some embodiments. The computing device 700 may, for example, be a smartphone such as an iPhone™ or other mobile device running the iOS™ operating system, the Android™ operating system, a BlackBerry™ operating system, the Microsoft® Windows® Phone operating system, Symbian™ OS, or webOS™, as would be consistent with client device 106 or client device 108. Computing device 700 may also be a tablet computer such as the iPad™ or other similar device running the aforementioned operating systems. Computing device 700 may also be personal computer, laptop computer, netbook, or tablet computer as also would be consistent with client device 106 or client device 108. The computing device 700 may include a processor 710. The processor 710 may be any of a variety of different types of commercially available processors suitable for mobile devices (e.g., an XScale architecture microprocessor, a Microprocessor without Interlocked Pipeline Stages (MIPS) architecture processor, or another type of processor). A memory 720, such as a random access memory (RAM), a Flash memory, or other type of memory, is typically accessible to the processor 710. The memory 720 may be adapted to store an operating system (OS) 730, as well as application programs 740, such as a mobile location enabled application that may provide location based services (e.g., physical location check-in) to a user. The processor 710 may be coupled, either directly or via appropriate intermediary hardware, to a display 750 and to one or more input/output (I/O) devices 760, such as a keypad, a touch panel sensor, a microphone, and the like.

Similarly, in some embodiments, the processor 710 may be coupled to a transceiver 770 that interfaces with an antenna 790. The transceiver 770 may be configured to both transmit and receive cellular network signals, wireless data signals, or other types of signals via the antenna 790, depending on the nature of the computing device 700. In this manner, the connection 118 with the network 104 may be established. Further, in some configurations, a GPS receiver 780 may also make use of the antenna 790 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a FPGA or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

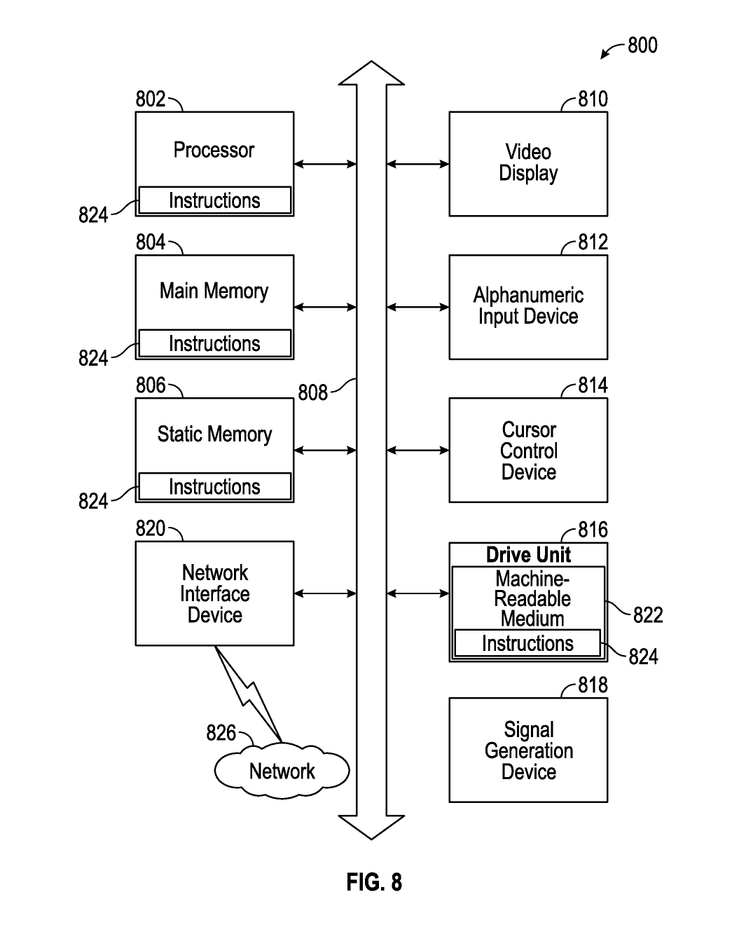

FIG. 8 is a block diagram of machine in the example form of a computer system 800 within which instructions 824 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a UI cursor control device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or used by any one or more of the methodologies or functions described herein. The instructions 824 may also reside, completely or at least partially, within the main memory 804, static memory 806, and/or within the processor 802 during execution thereof by the computer system 800, with the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more data structures or instructions 824. The term “machine-readable medium” shall also be taken to include any tangible medium that is capable of storing, encoding, or carrying instructions (e.g., instructions 824) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed:

1. A system comprising:
a processor of a machine; and
a tangible machine-readable storage medium storing:
a social media monitoring module configured to scan a plurality of social network entries made by users on one or more social networks;
an analysis module configured to identify at least one seller keyword from a first entry of the plurality of social network entries, the first entry made by a first user, the first entry identifying a product, the at least one seller keyword being indicative of a product available for sale, the analysis module further configured to identify an intent of a second user to purchase the product, the analysis module further configured to determine that the first user and the second user are a match based on the product available for sale and the intent of the second user to purchase the product; and
a communication module configured to communicatively connect the first user and the second user in response to determining that the first user and the second user are a match.

2. The system of claim 1, wherein the communicatively connecting the first user and the second user comprises transmitting a first message to the second user, the first message indicating that the first user intends to sell the product.

3. The system of claim 2, further comprising transmitting a second message to the first user, the second message indicating that the second user intends to purchase the product.

4. The system of claim 1, wherein the analysis module configured to identify the intent of the second user to purchase the product comprises the analysis module identifying at least one buyer keyword from a second entry of the plurality of social network entries, the second entry being made by the second user, the second entry identifying the product, the at least one buyer keyword being indicative of a potential purchase of the product by the second user.

5. The system of claim 1, wherein the analysis module configured to identify the intent of the second user to purchase the product comprises the analysis module receiving a key word search from the second user, the key word search being related to the product.

6. The system of claim 1, wherein the analysis module configured to identify the intent of the second user to purchase the product is based on a user profile of the second user, the user profile being maintained by a network-based marketplace.

7. The system of claim 1, wherein the plurality of social network entries include at least one of an activity feed post, a wall post, a status update, a tweet, a pinup, a like, or a check-in.

8. The system of claim 1, wherein the first social network entry includes a hyperlink corresponding to a network-based marketplace listing for the product.

9. A method comprising:
scanning a plurality of social network entries made by users on one or more social networks;
identifying at least one seller keyword from a first entry of the plurality of social network entries, the first entry made by a first user, the first entry identifying a product, the at least one seller keyword being indicative of a product for sale;
identifying an intent of a second user to purchase the product;
determining, by a processor of a machine, that the first user and the second user are a match based at least in part on at least one seller keyword and the intent of the second user to purchase the product; and
in response to determining that the first user and the second user are a match, communicatively connecting the first user with the second user.

10. The method of claim 9, wherein the communicatively connecting the first user and the second user comprises:
transmitting a first message to the first user, the first message indicating that the second user intends to purchase the product; and
transmitting a second message to the second user, the second message indicating that the first user indents to sell the product.

11. The method of claim 10, wherein the first and second messages are electronic mail messages (e-mail).

12. The method of claim 9, wherein the identifying of the intent of the second user to purchase the product comprises identifying at least one buyer keyword from a second entry of the plurality of social network entries, the second entry being made by the second user, the second entry identifying the product, the at least one buyer keyword being indicative of a potential purchase of the product.

13. The method of claim 12, wherein the determining that the first user and the second user are a match comprises:
determining the first user is a potential seller based on the at least one seller keyword;
determining the second user is a potential buyer based on the at least one buyer keyword; and
determining the first user and the second user are referring to the same product.

14. The method of claim 9, wherein the identifying of the intent of the second user to purchase the product comprises receiving a key word search from the second user, the key word search being related to the product.

15. The method of claim 9, wherein the identifying of the intent of the second user to purchase the product is based on a user profile of the second user, the user profile being maintained by a network-based marketplace.

16. The method of claim 9, wherein the plurality of social network entries include at least one of an activity feed post, a wall post, a status update, a tweet, a pinup, a like, or a check-in.

17. The method of claim 9, wherein the first social network entry includes a hyperlink corresponding to a network-based marketplace listing for the product.

18. A non-transitory machine-readable storage medium embodying instructions that, when executed by a machine, cause the machine to perform operations comprising:
scanning a plurality of social network entries made by users on one or more social networks;
identifying at least one seller keyword from a first entry of the plurality of social network entries, the first entry made by a first user, the first entry identifying a first product, the at least one seller keyword being indicative of a product offered for sale;
identifying at least one buyer keyword from a second entry of the plurality of social network entries, the second entry being made by the second user, the second entry identifying a second product, the at least one buyer keyword being indicative of a potential purchase of the second product;
determining that the first user and the second user are a match based on a relationship between the first product and the second product; and
in response to determining that the first user and the second user are a match, communicatively connecting the first user with the second user.

19. The non-transitory machine-readable storage medium of claim 18, wherein the first product and the second product are identical.

20. The non-transitory machine-readable storage medium of claim 18, wherein the first product is a version of the second product.
